(19) United States
(12) Patent Application Publication
(10) Pub. No.: US 2015/0228017 A1
(43) Pub. Date: Aug. 13, 2015

(54) METHODS AND SYSTEMS FOR APPROVAL OF CREDIT

(71) Applicants: Zulfiqar N. Momin, Sugar Land, TX (US); Ahmed Moledina, Austin, TX (US)

(72) Inventors: Zulfiqar N. Momin, Sugar Land, TX (US); Ahmed Moledina, Austin, TX (US)

(73) Assignee: FUEL SIGNAL, Austin, TX (US)

(21) Appl. No.: 14/617,382

(22) Filed: Feb. 9, 2015

Related U.S. Application Data
(60) Provisional application No. 61/939,080, filed on Feb. 12, 2014.

(51) Int. Cl. G06Q 40/02; G06Q 50/06; G06Q 30/06

(52) U.S. Cl. CPC G06Q 40/025; G06Q 50/06; G06Q 30/06

(57) ABSTRACT

Embodiments disclosed herein provide systems and methods for approving financial credit to purchase goods and/or services carried by a gas retailer. In embodiments, the approval of financial credit may be triggered responsive to an initiator action associated with a fuel level in a vehicle being triggered.

### CROSS-REFERENCE TO RELATED APPLICATIONS

This application claims a benefit of priority under 35 U.S.C. §119 to Provisional Application No. 61/939,080 filed on Feb. 12, 2014, which is fully incorporated herein by reference in its entirety.

### BACKGROUND INFORMATION

1. Field of the Disclosure

Examples of the present disclosure relate to techniques for real-time approval of credit. More particularly, embodiments are related to real-time approval of credit based on vehicle metrics, wherein the approval of credit may occur before a vehicle arrives at a gas retailer.

2. Background

Conventionally to fill up a vehicle with fuel, a user must drive to a gas station, get out of the vehicle, pay for the fuel via credit card or cash, and fuel the vehicle. For example, upon arriving at a gas station, the user is required to pay at the gas pump via credit card or enter the gas station for other payment methods. Therefore, to fill up a vehicle with fuel via conventional methods, the user is required to expend a prolonged period of time outside the vehicle to pay for and fuel the vehicle.

However, situations may arise when the user wants to fill up the vehicle with fuel more quickly and/or the user does not desire to leave the vehicle for prolonged periods of time. For example, during inclement weather, the user may not desire to be outside of the vehicle while filling up the vehicle.

Accordingly, needs exists for more efficient and effective systems and methods for a user to fill up a vehicle at a gas retailer, where the user may not be required to exit the vehicle to complete a transaction for the fuel.

### SUMMARY

Embodiments disclosed herein provide systems and methods for approving financial credit to purchase goods and/or services carried by a gas retailer. In embodiments, the approval of financial credit may be triggered responsive to a low fuel sensor in a vehicle being initiated. Responsive to the low fuel sensor being triggered, participating financial institutions may be queried, and credit approval or a prepaid code may be transmitted to a client computing device associated with the vehicle. The credit approval or prepaid code may be approved for an amount associated with purchasing the fuel to fill up the vehicle and/or buy goods and/or services carried by the gas retailer. In embodiments, a bank linked account or prepaid approval may be converted into an egift card by gas brands to use at the pump. The credit card company or proprietary gas brand credit card may provide cents off discount to the customer since the credit card company or the proprietary gas brand knows the low fuel indicator is triggered and how much fuel the consumer may purchase. At the time of prepaid code transmittal, they may discount the cents off per gallon and charge less to the customer. For example; 12 gallons of gas at $1.50 may equal $18.00. Financial institutions or branded gas companies may offer 5 cents off per gallon and charge the user only $17.40 in total and provide $18.00 in gift card value. This may drive traffic in real-time to branded gas station like Shell, Exxon, and Chevron. Responsive to a low fuel indicator being triggered, a query may be made to financial institutions to receive bids to complete the financial transaction. The winning bid may be associated with the financial institution with the highest rewards.

The credit approval or prepaid code may eliminate, reduce, or limit credit card transaction fees that a gas retailer is required to pay for completing transaction. Embodiments may enable a financial institution (e.g. a credit card provider, egift card provider, a debit card provider, a loyalty card provider, etc.) to receive money from a consumer's bank account that is linked with a logic server, and credit the deposit to a bank account linked with gas retailer. The credit deposited may be completed in real-time or via an End-of-Day (EOD) batch process.

In other embodiments, financial institutions may offer the credit to consumers in real-time via a financial institution that is linked to the consumer before the consumer arrives at the gas retailer. Consumers may receive real-time financial credit approval before they arrive at a promotion retailer since the consumer has already searched for coupons. Therefore, the financial institutions may predict the transaction.

In embodiments, the real-time credit approval that is triggered by the vehicle's low fuel sensor may reduce, limit, or eliminate credit card processing fees charged to gas retailers when completing transactions. If the consumer already has a credit card and no real-time credit approval is required, then the financial institution linked to the credit card may provide discounts, rewards, and/or lower credit card transaction fees to the retailer.

In embodiments, the amount of credit that is approved for the consumer may be based on a quantity of fuel necessary to reach a desired level upon the vehicle arriving at the gas retailer (fuel discount), which may be based on the price of fuel, amount of fuel in the vehicle when the vehicle's low fuel sensor is initiated, the vehicle's tank size, the distance between the vehicle and the gas retailer, vehicle type, fuel consumption to arrive at the gas retailer, etc.

In embodiments, the amount of credit that is approved for the consumer may be determined at a location that is remote from the gas retailer, and may be approved responsive to a triggering event. Trigging events may be based on the vehicle's telemetric and/or sensors, such as the low fuel sensor.

In further embodiments, the amount of approved credit may also be based on the consumer's purchasing history or coupons transmitted to the consumer. If it is determined that the consumer is likely to purchase goods and/or services carried by the gas retailer or another retailer, the amount of credit may be approved based on what goods and/or services the consumer is likely to purchase.

In embodiments, the consumer may be able to complete a transaction for the fuel over a wireless protocol (e.g. Near Field Communications protocol (NFC), ISO, ECMA, ETSI, etc.) at the gas retailer. In further embodiments, responsive to the consumer be approved for the amount of financial credit, a code may be transmitted to a client computing device associated with the consumer. Using the wireless protocol and the prepaid credit approval or code, the consumer may automatically pay for the amount of fuel at the gas retailer without exiting the vehicle. By using the wireless protocols and the prepaid credit approval, the amount of time required to fill up a vehicle with fuel may be drastically reduced.

In embodiments, a gas pump, electric fuel charging station, or other type of fuel station (referred to hereinafter as “fuel station) at the gas retailer may be configured to locate a fuel inlet port of the vehicle upon the vehicle being located at the gas retailer. Responsive to the fuel station determining the location of the fuel inlet port of the vehicle, a fuel outlet port of the fuel station may be configured to automatically interface with the fuel inlet port to supply fuel to the vehicle. Utilizing the automated fuel station and the wireless protocol to pay for the fuel, the consumer may not be required to exit the vehicle to insert the fuel outlet port of the fuel station into the vehicle's fuel inlet port or to pay for the fuel.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a topology for allowing a consumer to receive financing approval of credit to purchase goods and/or services carried by a gas retailer, according to an embodiment.

FIG. 2 depicts a logic server, according to an embodiment.

FIG. 3 depicts a financial institution computing device, according to an embodiment.

FIG. 4 depicts a gas retailer computing device, according to an embodiment.

FIG. 5 depicts a method for approving a financial transaction at a gas retailer via financial institutions bidding to complete the transaction, according to an embodiment.

FIG. 6 depicts a method for approving a financial transaction at a gas retailer via financial institutions bidding to complete the transaction, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein provide systems and methods for approving financial credit to purchase goods and/or services carried by a gas retailer. In embodiments, the approval of the financial credit for a consumer may be triggered responsive to an initiator action being triggered or mileage tracking data preset in a consumer's profile. More specifically, responsive to the initiator action being triggered, financial institutions may be queried, and credit approval or a prepaid code may be transmitted to the consumer.

The credit approval or prepaid code may be approved automatically or responsive to the consumer performing actions on a client computing device. Upon the approval, the consumer may purchase the fuel to fill up the vehicle and/or buy goods and/or services carried by the gas retailer, which may be completed with a lower transaction fee between the gas retailer and the financial institutions for the consumer to purchase fuel at the gas retailer. Therefore, the gas retailer may receive a benefit from lower transactions fees associated with the fuel transaction, which may be applied to consumers receiving a lower price for fuel.

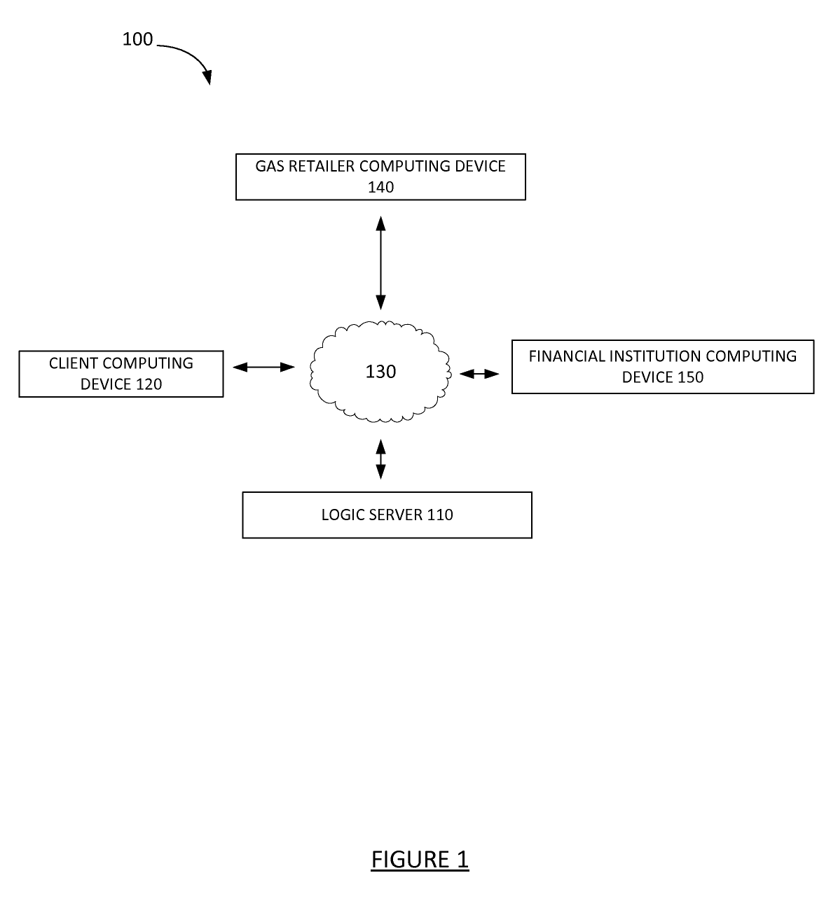

Turning now to FIG. 1, FIG. 1 depicts one topology 100 for allowing a consumer to receive financing approval of credit to purchase goods and/or services carried by a gas retailer. Topology 100 may include a logic server 110, client computing device 120, a gas retailer computing device 140, and financial institution computing device 150. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Client computing device 120 may be a smart phone, tablet computer, laptop computer, a computer embedded within a vehicle, a computer coupled to a vehicle's processor and/or the vehicle's sensors, personal data assistant, or any other type of mobile device with a hardware processor that is configured to process instructions and connect to one or more portions of network 130. Client computing device 120 may be configured to determine the location of client computing device 120, receive inputs from the consumer's, determine if a vehicle's low fuel sensor has been initiated, determine an amount of fuel within a vehicle's tank, complete a financial transaction for good and/or services carried by a gas retailer over a wireless protocol, and/or transmit information to be approved for credit at a financial institution. Client computing device 120 may be further configured to transmit the determined information and inputs to logic server 110.

In embodiments, client computing device 120 may include a user interface with a touch screen finger payment method. Client computing device 120 may be configured to store mobile wallet payment systems and methods for a user within the dashboard and/or any other desired location with the car. If a user desires to purchase fuel and/or any other goods and/or services at a gas retailer, the user may perform actions on the user interface within the vehicle to authorize the payment. The transaction may be facilitated between financial institutions and the gas retailer. Thus, the user interface may streamline a transaction process, while allowing the user to complete a transaction without leaving the vehicle.

Financial institution computing device 150 may be a hardware computing device that is associated with a financial institution, such as a bank, loyalty card, or credit card company. Financial institution computing device 150 may be configured to allow consumers associated with client computing device 120 to purchase fuel and/or other goods and/or services carried by a gas retailer.

In embodiments, the financial institutions may include prepaid debit cards, e-gift cards, loyalty cards, and/or credit cards, which may be linked to a consumer and be associated with a gas retailer. For example, a first financial institution may include an Exxon Visa credit card, and the consumer may have an Exxon Visa credit card and the gas retailer may be an Exxon gas retailer. Linked financial institutions may be configured to receive information indicating that a vehicle associated with client computing device 120 may require fuel, wherein the information may include a price for the amount of fuel required by the vehicle. Responsive to receiving the information, different linked financial institutions may bid to approve the financial transaction to fill up the vehicle with fuel.

The bids may be presented as a percentage of the financial transaction that the financial institution may receive upon completing the financial transaction for the fuel. For example, a first bid from a first financial institution may be a three percent bid that the gas retailer has to pay the financial institution responsive to completing a transaction, a second bid from a second financial institution may be a one percent bid for completing the same transaction. Similarly, the bid may be based on how much the financial institution is offering rewards or loyalty points on a fuel purchase. In further embodiments, the bids may be associated with rewards, points, a lowered interest rate given to the consumer, discounts, etc. (referred to hereinafter collectively and individually as “bids”). The bids, rewards, points, discounts, etc. may be linked with a loyalty rewards program and the consumer.

The financial institution with the lowest bid may be able to approve the financial transaction. In embodiments, the bids may be received before the client computing device 120 transmits the request for credit, such that a financial institution has a predetermined bid with a gas retailer. For example, a financial institution associated with a Visa Exxon credit card may have a standing one percent bid for all transactions associated with Exxon gas retailers. In further embodiments, the bids may be received hourly, daily, weekly, etc., such as at the start of the week, wherein the bids indicate a financial institution, gas retailers, and credit limits.

In further embodiments, the consumer may perform actions that the consumer desires to use a credit card, gift card, loyalty card, rewards card with the lowest bid to complete the financial transaction. This may allow the consumer to receive a lower fuel price. In other embodiments, the consumer may be presented with gas prices associated with each of the cards at a gas retailer to complete the transaction. The gas prices may be based on the price of fuel at a gas retailer, the financial institution's bid, and/or a rebate the consumer based on the financial institution's bid and amount of the completed transaction. To this end, topology 100 may reduce, limit, or eliminate the amount of money that gas retailers pay credit card companies to approve the financial transactions.

Gas retailer computing device 140 may be a hardware computing device that is associated with a gas retailer, chain of gas retailers, sets of gas retailers that are commonly owned, etc. Gas retailer computing device 140 may be configured to allow consumers to purchase fuel and other goods and/or services carried by the gas retailer.

In embodiments, gas retailer computing device 140 may be linked with at least one financial institution. For example, a gas retailer such as Exxon may be linked with an Exxon credit card financial institution. One skilled in the art will appreciate that while only one gas retailer computing device 140 is depicted in topology 100, topology 100 may include multiple gas retailer computing devices 140, wherein the multiple gas retailer computing devices 140 may be associated with the same financial institutions, different financial institutions, or no financial institutions.

Logic server 110 may be a computing device, such as a general hardware platform server configured to support mobile applications, software, and the like executed on client computing device 120, gas retailer computing device 140, and/or financial institution computing device 150. Logic server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Logic server 110 may include any combination of one or more computer-usable or computer-readable media. For example, Logic server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Logic server 110 may be configured to receive metrics from a vehicle associated with client computing device 120, store profile information associated with a consumer associated with client computing device 120, determine an amount of fuel required to fill up a vehicle, transmit and receive financial information associated with approving a financial transaction, receive information associated with fuel prices at a gas retailer, and/or manage a bidding system, wherein financial institutions may bid to approve transactions between the consumer for a financial transaction for fuel and/or goods and services purchased at a gas retailer.

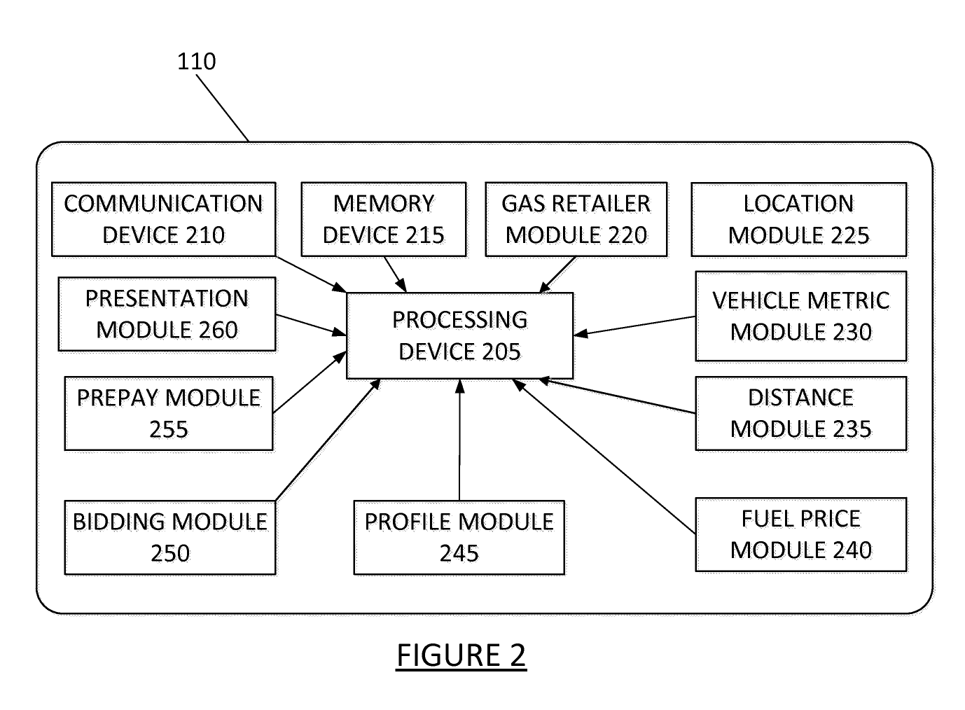

FIG. 2 depicts one embodiment of logic server 110. Logic server 110 may be configured to approve credit for a financial transaction for an amount of fuel, wherein the credit may be approved responsive to a low fuel sensor within a vehicle being initiated. Logic server 110 may also be configured to limit, reduce, or eliminate processing fees between financial institutions and gas retailers to complete the financial transaction for the amount of fuel.

Logic server 110 may include a processing device 205, a communication device 210, a memory device 215, a gas retailer module 220, a location module 225, a vehicle metric module 230, a distance module 235, a fuel price module 240, a profile module 245, a bidding module 250, a prepay module 255, and a presentation module 260.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of logic server 110 or software associated with other elements of logic server 110.

Communication device 210 may be a device that allows logic server 110 to communicate with another device over a wireless or wired network, such as network 130. Communication device 210 may include one or more wireless transceivers for performing wireless communication and/or one or more communication ports for performing wired communication. Communication device 210 may be configured to communicate data over a plurality of different standard and/or protocols.

Memory device 215 may be a device that stores data generated or received by logic server 110. Memory device 215 may include, but is not limited to a hard disc drive, an optical disc drive, and/or a flash memory drive. In embodiments, memory device 215 may be configured to store information received from a client computing device 120 and/or a gas retailer computing device 140. The information stored within memory device 215 may be accessed by processing device 205, communication device 210, and/or modules 220, 225, 230, 235, 240, 245, 250, 255, 260.

Gas retailer module 220 may be a hardware processor configured to receive retailer information from a gas retailer computing device 140, wherein the retailer information may be associated with a gas retailer. The retailer information may include an inventory of goods and/or services offered by the gas retailer, prices of the inventoried items (e.g. prices of fuel, prices of food within the retailer, etc.), and a location of the gas retailer.

Location module 225 may be a hardware processing device configured to determine the location of a gas retailer or client computing device 120. A location may be represented in geographic coordinates, Cartesian coordinates, e.g., an (x, y) point on a map if the map is divided into a Cartesian plane, and/or may be represented using reference points. In embodiments, location module 225 may determine the location of a gas retailer based on an employee associated with the gas retailer performing actions to enter location information for the gas retailer. The location information may be subsequently transmitted to logic server 110. Responsive to receiving the location information associated with the gas retailer, location module 225 may store the location information within a corresponding entry for the gas retailer within a database within memory device 215.

Location module 225 may also be configured to determine the location of client computing device 120 responsive to receiving location information from client computing device 120 or responsive to transmitting requests for location information to client computing device 120. In embodiments, location module 225 may be configured to receive the location information of client computing device 120 at set intervals, which may be any desired period of time (e.g., every 1/10^{th} of a second, every second, every minute, every ten minutes, etc.), based on the consumer's settings within the consumer's profile, an initiator action being triggered based on the vehicle's telematics occurring, or responsive to the consumer performing actions on client computing device 120. Location module 225 may determine the location of client computing device 120 via any known means, such as a RTLS WiFi, radar, mobile device tracking, time distance of arrival (TDOA) signals, short wave radio, Bluetooth, etc. Responsive to determining the location of client computing device 120, location module 225 may store, within a corresponding entry of database within memory device 215. The location information may include a time stamp identifying the time that the location of the vehicle is determined.

Vehicle metric module 230 may be a hardware processing device configured to receive vehicle information from client computing device 120. Vehicle metric module 230 may receive information associated with an initiator action being triggered. An initiator action may be associated with the vehicle being low on fuel, the vehicle having a certain number of miles to empty, a fuel metric indicating that the vehicle has a certain number of miles to travel on the current fuel tank, a fuel metric indicating the amount of fuel until the vehicle's fuel tank is empty, a fuel metric indicating the maximum amount of fuel the vehicle's fuel tank may store, maintenance information corresponding to the vehicle, (e.g. a check engine light, oil level, etc.), thresholds sets within the consumer's profile, or any other information associated with when the vehicle may visit a gas retailer.

Vehicle metric module 230 may receive the vehicle information at set intervals, which may be any desired period of time (e.g., every 1/10^{th} of a second, every second, every minute, every ten minutes, every hour, every day, a etc.), received simultaneously with the location information, responsive to an amount of fuel within the vehicle being below a fuel threshold level (e.g. the vehicle has ten miles, twenty miles, fifty miles before the tank is empty or the vehicle's tank has one, two, five gallons of fuel remaining), or a low-level fuel light being initiated.

Distance module 235 may be a hardware processing device configured to calculate the distance between a vehicle and a gas retailer. Distance module 235 may determine the distance between client computing device 120 and a gas retailer. The determined distance may be based on the location information associated with client computing device 120 and the location information associated with the gas retailer, map information associated with the surrounding environment (i.e. lengths of roads), and directions between client computing device 120 and the gas retailer.

Distance module 235 may also be configured to be a navigation device that may provide driving instructions using a combination of text, symbols, voice guidance, and a moving map. Distance module 235 may calculate a route between client computing device 120 and the gas retailer as applied to the map information stored within memory device 215, all major actions (e.g. turning corners, crossroads, roundabouts, etc.) that are schematically depicts by arrows or other indicated overlaid on the route. The route may also include an action indicator showing the distance to the next actions, the name of the current road, an estimated time before arriving at the retailer, etc.

Fuel price module 240 may be a hardware processor configured to determine a price for a transaction. The price of the transaction may be based on an amount of fuel required for a vehicle to completely fill a gas tank at the gas retailer. The amount of fuel required for the vehicle to arrive at the gas retailer may be determined responsive to an initiator action occurring.

In embodiments, the initiator action may be associated with the vehicles metrics, such as an amount of fuel within the vehicle being below a fuel threshold level or a low-level fuel light being initiated. In one embodiment, fuel price module 240 may determine the price for the amount of fuel required by determining an estimated amount of fuel within the vehicle upon the vehicle reaching the retailer (e.g. the vehicle's current fuel level minus the estimated amount of fuel required to travel to the retailer). Next, fuel price module 240 may determine the difference between the vehicle's maximum fuel capacity and the vehicle's estimated fuel level upon reaching the retailer. Then, fuel price module 240 may multiply the determined difference by the price of a desired fuel type to determine the price for the amount of fuel required to maximize the vehicle's fuel level minus any discounts, wherein the desired fuel type may be preselected based on the consumer's preferences stored within the consumer's profile. The fuel type may be automatically entered by logic server 110 based on the users purchasing history of fuel minus any discounts at a gas retailer for the vehicle, or the fuel type may be entered by a user performing actions on client computing device 120 to enter a desired fuel type.

One skilled in the art will appreciate that fuel price module 240 may also be configured to determine a price associated with goods and/or services that the consumer may purchase at the gas retailer. The price for goods and/or services may be included when preapproving the transaction to maximize the vehicles fuel level. In embodiments, the price for goods and/or services may be determined based on the consumer's purchasing history, consumer preferences stored within the consumer's profile, a buffer zone (e.g. always preapprove ten more dollars), or any desired amount.

Profile module 245 may be a hardware processing device configured to allow a consumer associated with client computing device server 120 to generate and create a consumer profile. The consumer's profile may include information stored in memory device 215 and/or other storage locations. The consumer profiles may include user information, vehicle information, and banking information.

The user information may include information identifying the consumer (e.g., a username or handle, a number, an identifier, and/or other identifying information, a social security number, driver's license number, utility or phone bill to verify the current residence of the consumer, etc.), security login information (e.g., a login code or password), demographic information associated the consumer, purchase history of the consumer, driving style information associated with the consumer, or any other information associated with the consumer. Using the user information, the consumer may be pre-approved by financial institutions for a certain amount of credit in real time.

The vehicle information may include information corresponding to the vehicle, such as the vehicle's make or model, the vehicles average mileage on a highway or standard road, a vehicle's maximum capacity for fuel, fuel type, etc.

The banking information may include payment information associated with methods of payments (e.g., credit card information, prepaid debit card information, cash account, etc.). The banking information may be linked to financial institutions, which may or may not be associated with a gas retailer. For example, the consumer may have a credit card that is associated with both a first gas retailer (e.g. an Exxon Mobile service station) and a first financial institution (e.g., a Visa Exxon Mobile credit card). Additionally, the consumer may have a credit card that is not associated with a gas retailer (e.g. a Chase debit card).

In embodiments, a consumer may link prepaid cards, credit cards, loyalty cards, e-gift cards, and a cash account to a bank account, which may be debited for fuel purchases and other goods and/or services purchased at a gas retailer, which may limit transaction costs. Utilizing the consumer's profile, the consumer may store information associated with linked credit cards, debit cards, loyalty cards, rewards cards, etc. to the consumer's account.

Bidding module 250 may be a hardware processing device configured to receive bids from financial institution computing devices 150 that have linked banking accounts to the consumer. The bids may be associated with approving a consumer to purchase fuel at a gas retailer, and may be determined responsive to the initiator action taking place within the vehicle. In embodiments, the bids may be received prior to the initiator action occurring, such that a financial institution may set a first bid price for a first method of payment associated with the consumer, and the financial institution may set a second bid price for a second method of payment associated with the consumer. Accordingly, the financial institutions may have standing bids for specific gas retailers, consumers, levels of credit, types of card, etc.

In response to the initiator action taking place, bidding module 250 may transmit preapproval information to financial institutions with accounts linked to the consumer. The preapproval information may indicate that the consumer desires to purchase fuel at a gas retailer, and may include the price to purchase the amount of fuel to fill up the vehicle as determined by fuel price module 240.

Upon transmitting the preapproval information, the financial institutions that are linked to the consumer's banking information may transmit bids to approve the financial transaction for the price to fill up the vehicle with fuel. In embodiments, the bids may be presented as a percentage of the financial transaction that the financial institution may receive upon completing the financial transaction for the price of the fuel. For example, a first bid from a first financial institution may be a three percent bid that the gas retailer will pay the financial institution responsive to the consumer completing a transaction for fuel. A second bid from a second financial institution may be a one percent bid that the second financial institution will pay responsive to the consumer completing the transaction for fuel. In embodiments, each financial institution may submit multiple bids for a transaction, wherein each bid may be associated with different methods of payments associated with the consumer.

Bidding module 250 may be configured to determine the financial institution with the lowest bid, and may allow the financial institution with the lowest bid to approve the financial transaction for the fuel transaction. Therefore, the amount of money required for gas retailers to complete financial transactions associated with fuel and goods and/or services may be reduced, limited, or eliminated.

In further embodiments, the transaction prices for the fuel may be transmitted to the client computing device, wherein the user may determine the method of payment to use for the transaction based on the varying prices for the transaction. Accordingly, the consumer may be presented with an option to use a credit card, debit card, loyalty card associated with the bids to complete the transaction. The transaction prices associated with purchasing the fuel may vary based on the received bids from the financial institutions and a rebate given to the user from the gas retailer. Accordingly, the gas retailer and the user may be incentivized to use a specific method of payment for the transaction.

Furthermore, because bidding module 250 may be configured to preapprove the price for the amount of fuel for the vehicle responsive to the initiator action, bidding module 250 may approve the fuel transaction before the consumer arrives at the gas retailer, which may save the consumer time to fill up the vehicle.

Responsive to approving the financial credit for the price of the fuel, the gas retailer may give the consumer a discount that corresponds to the amount of money that the gas retailer saved via the bidding processes versus a conventional method of completing transactions. For example, it may be determined that a conventional transaction price for using a credit card is a first percentage (e.g. three percent). If the bid to complete the transaction is a second percentage which is lower than the first percentage (e.g. one percent), the consumer may be given a discount of a third percentage, wherein the third percentage may be based on subtracting the second percentage from the first percentage. Therefore, the gas retailer may receive a benefit from lower transactions costs associated with the fuel transaction, and the consumer may receive a lower price for fuel.

Prepay module 255 may be a hardware processor configured to allow for the fuel transaction over a wireless protocol (e.g. Near Field Communications protocol (NFC), ISO, ECMA, ETSI, etc.) at a pump or other point of sale associated with a gas retailer. Prepay module 255 may be configured to allow for transactions, data exchange and wireless connections between two devices in close proximity to each other, such as client computing device 120 and a gas retailer computing device 140. Prepay module 255 may be configured to allow for contactless payment and financial transactions standards that may be used by the consumer associated with client computing device 120 to perform transactions. In embodiments, prepay module 255 may utilize NFC standards such that contactless credit cards, e-gift cards, loyalty cards, rewards cards, etc. can be used to complete fuel transactions. Thus, prepay module 255 may be utilized with cards, tags, and devices, including terminals, mobile devices and other consumer electronics devices to complete transactions over a wireless protocol without a user leaving the vehicle.

Prepay module 255 may also be configured to utilize the preapproved financial credit to complete a transaction for the fuel and other goods. Prepay module 225 may complete the transaction responsive to bidding module 250 determining a lowest or selected bid to complete the financial transaction at the gas retailer. In further embodiments, the selected bid may be associated with the highest number of rewards, points, etc. distributed to the consumer.

If the consumer does not desire to use the determined card associated with the lowest bid, the consumer may select another card to complete the transaction. Responsive to bidding module 250 determining the lowest bid, the consumer may utilize prepay module 255 to receive information corresponding to a real-time credit approval or prepaid code, such that the user may use the approval to complete a transaction for the predetermined price of fuel or groceries at the gas retailer. In embodiments, prepay module 255 may transmit the code to client computing device 120, client computing device 120 may present the code on a user interface, and a fuel station may wirelessly identify the code on user interface to authenticate the purchase of fuel and/or goods or services. Additionally, the consumer may scan a code on a NFC reader to validate or authenticate the code.

Presentation module 260 may be a hardware processing device configured to transmit information configured to be displayed on a user interface of the client computing device 120. The transmitted information may be associated with the vehicle's fuel metrics, the price of fuel at gas retailers, an estimated amount of fuel required at a gas retailer, the determined price required for the vehicle to be filled up with fuel minus any applicable discount from the gas retailer, if any, prices at gas retailer associated with a transaction and a method of payments based on the bids from the financial institutions, and/or an indicator that a financial institution has preapproved the consumer to purchase fuel at a gas retailer.

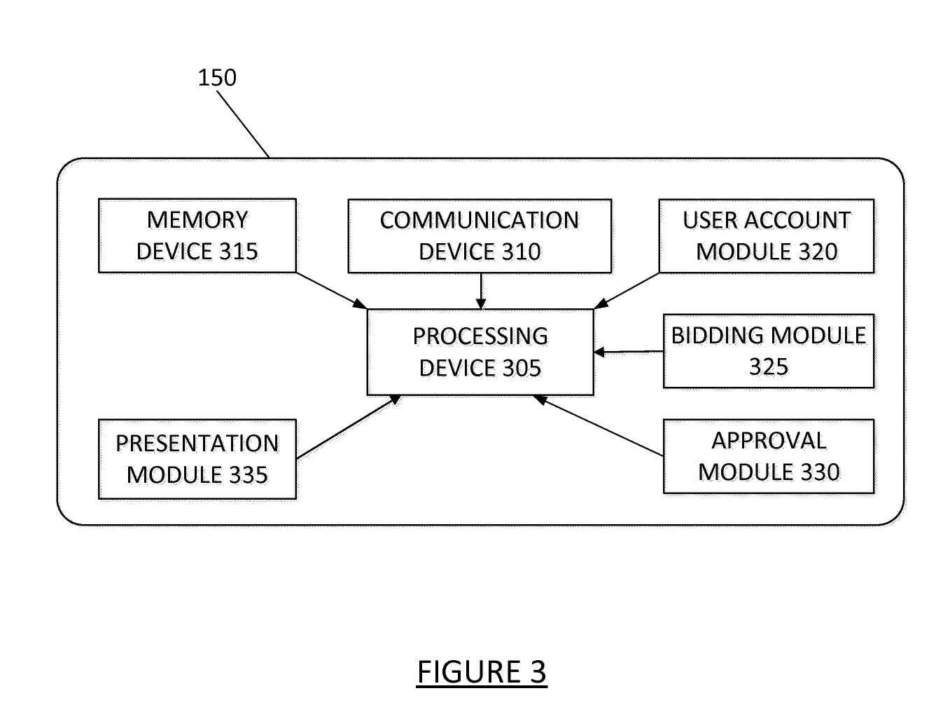

FIG. 3 depicts one embodiment of financial institution computing device 150. Financial institution computing device 150 may be associated with a financial institution that is linked to a consumer's bank account, and may be configured to complete a transaction for the consumer to purchase fuel and/or goods and/or services carried at a gas retailer. Financial institution computing device 150 may include a processing device 305, a communication device 310, a memory device 315, a user account module 320, bidding module 325, approval module 330, and a presentation module 335.

Processing device 305 may include memory, e.g., read only memory (ROM) and random access memory (RAM), storing processor-executable instructions and one or more processors that execute the processor-executable instructions. In embodiments where processing device 305 includes two or more processors, the processors may operate in a parallel or distributed manner. Processing device 305 may execute an operating system of financial institution computing device 150 or software associated with other elements of financial institution computing device 150.

Communication device 310 may be a device that allows financial institution computing device 150 to communicate with another device over a wireless or wired network, such as network 130. Communication device 310 may include one or more wireless transceivers for performing wireless communication and/or one or more communication ports for performing wired communication. Communication device 310 may be configured to communicate data over a plurality of different standard and/or protocols.

Memory device 315 may be a device that is configured to store data generated or received by financial institution computing device 150. Memory device 315 may include, but is not limited to a hard disc drive, an optical disc drive, and/or a flash memory drive. In embodiments, memory device 315 may be configured to store information received from a logic server 110 or client computing device 120, which may be associated with a consumer's financial information and/or approving credit for the consumer. The information stored within memory device 315 may be accessed by processing device 305, communication device 310, and/or modules 320, 325, 330, 335.

User account module 320 may be a hardware processing device configured to receive a consumer's bank account information to link a client computing device 120 with the financial institution. In embodiments, each method of payment associated with a user may be linked to at least one financial institution. User module 320 may also be configured to associate financial transactions performed by the consumer with the financial institution to process the financial transaction.

Responsive to user account module 320 receiving the bank account information from logic server 110 associated with a financial institution and the client, user account module 320 may parse information for identifying characteristics stored within memory device 315 that can be associated with the financial institution to determine what account is associated with the consumer.

Bidding module 325 may be a hardware processing device configured to transmit bids to approve a consumer's financial transaction at a gas retailer. In embodiments, bidding module 325 may be configured to transmit bids that are a percentage of the financial transaction, wherein the financial institution may receive the percentage of the transaction responsive to a transaction being completed. In embodiments, the bids may be based on a plurality of factors including what types of gas retailers a consumer typically uses, the location of the consumer, the location of gas retailers in close proximity to the consumer, time of day, types of financial institutions that are linked to the consumer's financial institution, time of day, day of the week, etc.

For example, if the consumer has financial information with that is linked to a financial institution, and the financial institution is also linked to a gas retailer (e.g. an Exxon Mobile Chase credit card) the financial institution's bid may for a first percentage. However, if the financial institution is not linked to the gas retailer, the financial institution's bid may be for a second percentage, wherein the first percentage is lower than the second percentage. By bidding module 325 being configured to bid to approve a financial transaction before the consumer completes the financial transaction, the financial institution may be able to increase the number of completed transactions activated by the consumer. In embodiments, the bids may be determined in real-time when an initiator action is transmitted, upon determining the price for a transaction, and/or predetermined before an initiator action is transmitted to logic server 110. Accordingly, logic server 110 may have already received bids for a transaction from bidding module 325 before an initiator action is transmitted to logic server 110.

Approval module 330 may be configured to approve a financial transaction at a gas retailer responsive to the financial institution having the lowest bid to complete the financial transaction or responsive to the financial institution being selected to complete the financial transaction. Approval module 330 may be configured to receive an authorization request including the consumer's banking information (e.g. credit card number, expiration date, billing address, CVV number, the price for the amount of fuel that the vehicle will use to fill up the consumer's vehicle at the gas station) and the bid percentage.

In embodiments, a number of stakeholders (e.g. credit card processors, acquirers, credit card issuing companies, financial institutions, etc.) may be associated with the financial transaction. The bid percentage may be a combination of all of the stakeholders, so that the real-time bid may lower one or more of the fees between stakeholders. Approval module 330 may then approve the transaction for the determined price of fuel that the vehicle will use to fill up the consumer's vehicle at the gas retailer. An indication of the approved transaction may be transmitted to logic server 110 and/or gas retailer computing device 140. The indication may include the preapproved price of the transaction and the bid percentage required to complete the financial transaction. In embodiments, the approval amount may be transmitted to logic server 110 or gas retailer computing device 140 in real-time or via an End-of-Day (EOD) batch process.

Presentation module 335 may be a hardware processor that may receive information from logic server 110, client computing device 120, and gas retailer computing device 140. The information may be configured to be displayed on financial institution computing device 140. In embodiments, presentation module 335 may receive and present information associated with a financial transaction at gas retailer, approval for a financial transaction, bid information, etc.

In embodiments, financial institution computing device 140 may also be configured to provide real-time rewards to client computing device 120, based on the goods and/or services purchased by a user from a gas retailer. The real-time rewards may be a discount on fuel, such as a percentage off the fuel price and/or a cash discount. The discount may be transmitted along with the financial institutions bid to complete the transaction between client computing device 120 and the gas retailer, wherein these discounts may be presented to the user. Because the financial institutions may be able to determine the price associated with the transaction associated with the vehicle's fuel level, maximum amount of fuel, fuel prices, and potential discounts, the offered discounts may be proportional the price of the transaction. Accordingly, as the price increases the discount may also increase.

Additionally, in embodiments, upon an initiator action being triggered by a vehicle, transmitting a bid, or being a selected financial institution to complete a transaction at a gas retailer, financial institution computing device 140 may randomly transmit a coupon to the user, wherein the coupon may be used at the gas retailer or a secondary retailer. For example, a coupon may include a free coffee, drinks, and/or other goods or services. The coupons may be used to promote products in real-time to increase brand product awareness and sales.

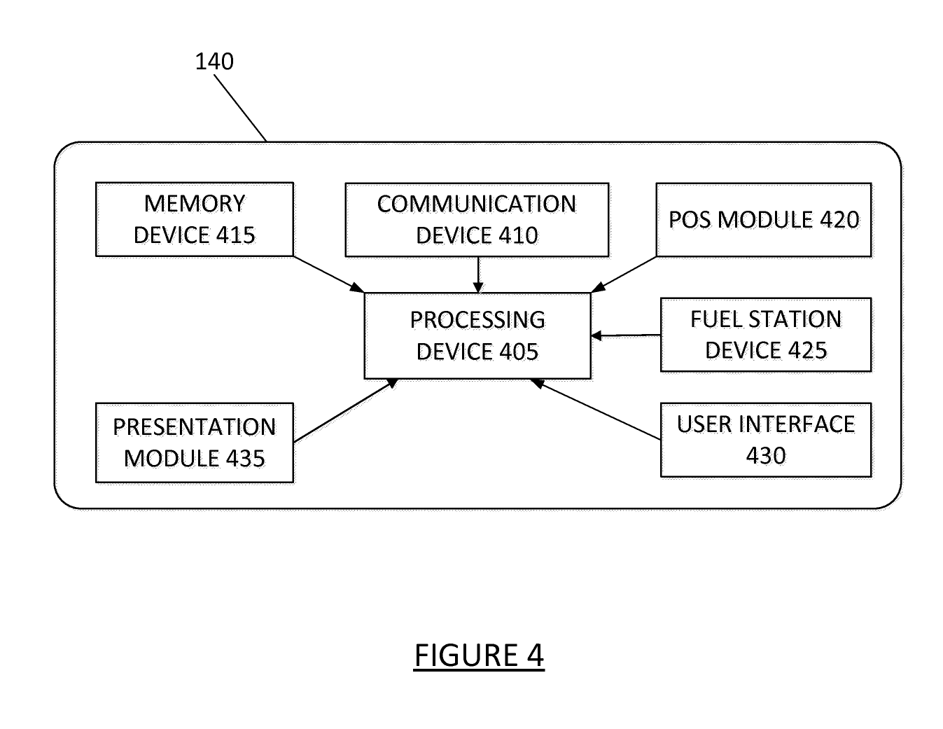

FIG. 4 depicts one embodiment of gas retailer computing device 140. Gas retailer computing device 140 may be configured to allow a gas retailer, an employee of a gas retailer or an administrator associated with a gas retailer to enter prices for fuel and goods and/or services carried by a gas retailer, allow a consumer to complete transactions at the gas retailer, and fill up a vehicle with fuel without the consumer having to exit the vehicle. Gas retailer computing device 140 may include processing device 405, communication device 410, a memory device 415, a point of sale (POS) module 420, fuel station device 425, a user interface 430, and a presentation module 435.

Processing device 405 can include memory, e.g., read only memory (ROM) and random access memory (RAM), storing processor-executable instructions, and one or more processors that execute the processor-executable instructions. In embodiments where processing device 405 includes two or more processors, the processors may operate in a parallel or a distributed manner. Processing device 405 may execute an operating system of gas retailer computing device 140 or software associated with other elements of retailer computing gas device 140.

Communication device 410 may be a device that allows gas retailer computing device 140 to communicate with another device, e.g., logic server 110, client computing device 120, or financial institution computing device 140 over network 130. Communication device 410 may include one or more wireless transceivers for performing wireless communication and/or one or more communication ports for performing wired communication.

Memory device 415 may be a device configured to store data generated or received by gas retailer computing device 140. Memory device 415 may include, but is not limited to a hard disc drive, an optical disc drive, and/or a flash memory drive. Memory device 415 may be configured to store data associated with a gas retailers location, a set of gas retailers locations associated with a chain or that are commonly owned, a gas retailers inventory, prices associated with fuel, etc.

POS module 420 may be a hardware computing device including a processor to assist a consumer with completing a transaction. POS module 420 may include a credit card reader, a receipt printer, a NFC sensor, a cash drawer, a barcode scanner, and/or a personal identification number (PIN) pad with an integrated card swipe. POS module 420 may be configured to receive an amount of fuel required to fill up a vehicle to maximum capacity from client computing device 120 associated with the vehicle and charge a payment method (e.g. a credit card, loyalty card, debit card, etc.) associated with the client computing device 120. POS module 420 may be configured to automatically charge the user's payment method for the determined price for the amount of fuel required to fill up the vehicle. Thus, the user may not be required to directly perform actions on POS module 420 to purchase fuel, and only be required to perform actions on client computing device 120 to purchase fuel. In embodiments, POS module 420 may be configured to complete the transaction for the price of fuel responsive to receiving a preapproval for the price from logic server 110 or financial institution computing device 150, which may be determined before the vehicle arrives at the gas retailer.

Fuel station device 425 may be a hardware device configured to dispense fuel into a vehicle. Fuel station device 425 may be configured to locate a fuel inlet port of the vehicle upon the vehicle being located at the gas retailer. Responsive to fuel station device 425 determining the location of the fuel inlet port of the vehicle, a fuel outlet port of fuel station device 425 may be configured to automatically interface with the fuel inlet port to supply fuel to the vehicle. Therefore, fuel station device 425 may be an automated device configured to dispense fuel into a fuel tank of a vehicle without user assistance. Utilizing automated fuel station device 425 and wireless POS module 420 to complete a transaction for the fuel, the consumer may not be required to exit the vehicle to insert the fuel outlet port of fuel station device 425 into the vehicle's fuel inlet port or to complete the transaction for the fuel.

User interface 430 may be a device that allows an associated a gas retailer to interact with gas retailer computing device 140, logic server 110, or client computing device 120 over a network. While one user interface is shown, the term “user interface” may include, but is not limited to being, a touch screen, physical keyboard, mouse, camera, video camera, microphone, and/or speaker. Utilizing user interface 430, an employee of the gas retailer may enter a price associated with fuel and/or inventoried items.

Presentation module 435 may be a hardware processor to receive information to be displayed on user interface 430 of gas retailer computing device 140. In embodiments, presentation module 435 may receive and present information associated with a consumer's profile, financial institutions, vehicle information, payment methods, bids from financial institutions, etc.

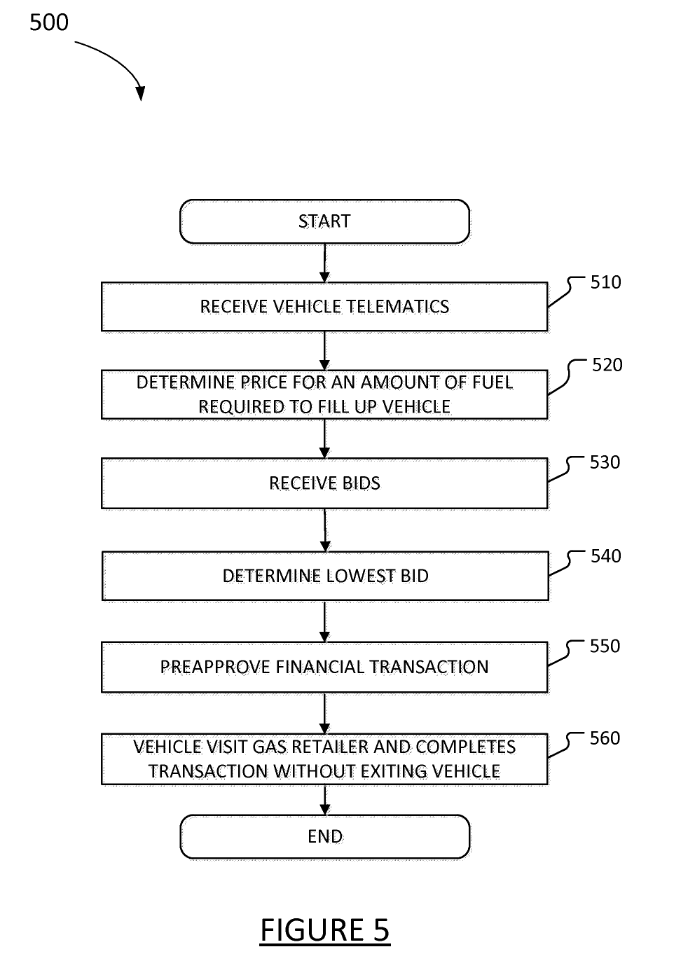

FIG. 5 illustrates a method 500 for approving a financial transaction at a gas retailer via financial institutions bidding to complete the transaction. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, vehicle telematics associated with a vehicle may be received. The vehicle telematics may be associated with an amount of fuel within the vehicle, and may be transmitted responsive to an initiator action being triggered. In embodiments, the amount of fuel within the vehicle may be determined by at least one sensor embedded within or communicatively coupled to a fuel tank of the vehicle. Operation 510 may be performed by a vehicle metric module that is the same as or similar to vehicle metric module 230, in accordance with one or more implementations.

At operation 520, a price for a transaction may be determined. The price may be based on the amount of fuel required by the vehicle to be at maximum capacity upon being filled up at the gas retailer and the price of fuel at the gas retailer. To determine the price for the amount of fuel required for the vehicle at the gas retailer, the vehicle's current fuel level, the amount of fuel required to reach the gas retailer, fuel prices at the gas retailer, and the maximum level of fuel allotted by the vehicle may be determined. The vehicle's estimated fuel level upon reaching the gas retailer may be based on the vehicle's location, the location of the gas retailer, the type of vehicle being driven, and a driven profile of the consumer. The determined difference between the vehicle's fuel level upon reaching the gas retailer and the maximum amount of fuel allotted by the vehicle may be multiplied by the price of a desired fuel type and discounts or promotions may be applied, wherein the desired fuel type may be preselected based on the consumer's preferences stored within the consumer's profile. Operation 520 may be performed by a fuel price module that is the same as or similar to fuel price module 240, in accordance with one or more implementations.

At operation 530, bids from financial institutions to approve the transaction for the determined price to fill up the vehicle at the gas retailer may be received. The bids may be received from financial institutions, and the bids may be a percentage of the financial transaction that the financial institution may receive upon the financial transaction for the price of the fuel being completed. Operation 530 may be performed by a bidding module that is the same as or similar to bidding module 250, in accordance with one or more implementations.

At operation 540, the selected bid received from the financial institutions may be determined. The selected bid may be selected by a user, gas retailer, or may be the lowest bid receiver. Additionally, information may be received indicating that the consumer has performed actions to complete the financial transaction utilizing the financial institution associated with the selected bid. Operation 540 may be performed by a bidding module that is the same as or similar to bidding module 250, in accordance with one or more implementations.

At operation 550, the financial institution with the selected bid may preapprove the consumer to purchase fuel at a gas retailer at the determined price for the amount of fuel to fill up the vehicle's gas tank. To preapprove the consumer to purchase fuel at the retailer via debit cards, credit cards, loyalty cards, etc., the financial institution associated with the lowest bid may receive an authorization request including the consumer's banking information (e.g. debit card number, credit card number, expiration date, billing address, CVV number, the price for the amount of fuel that the vehicle will use to fill up the consumer's vehicle at the gas station) and the bid percentage. An indication of the approved transaction may then be received. The preapproval may be made at a location that is remote from the gas retailer, and may be made responsive to receiving the initiator action being triggered. Operation 550 may be performed by a bidding module that is the same as or similar to bidding module 250, in accordance with one or more implementations.

At operation 560, the vehicle may visit the gas retailer and complete the transaction to fill up the vehicle with fuel or a desired fill level (e.g. quarter tank, half tank, etc.). The transaction for the fuel may be completed via a wireless protocol between a fuel station at the gas retailer and the client computing device. In further embodiments, a fuel station at the gas retailer may be configured to locate a fuel inlet port of the vehicle upon the vehicle being located at the gas retailer. Responsive to the fuel station determining the location of the fuel inlet port of the vehicle, a fuel outlet port of the fuel station may be configured to automatically interface with the fuel inlet port to supply fuel to the vehicle. Therefore, the consumer may be configured to complete a transaction for the fuel without having to exit the vehicle.

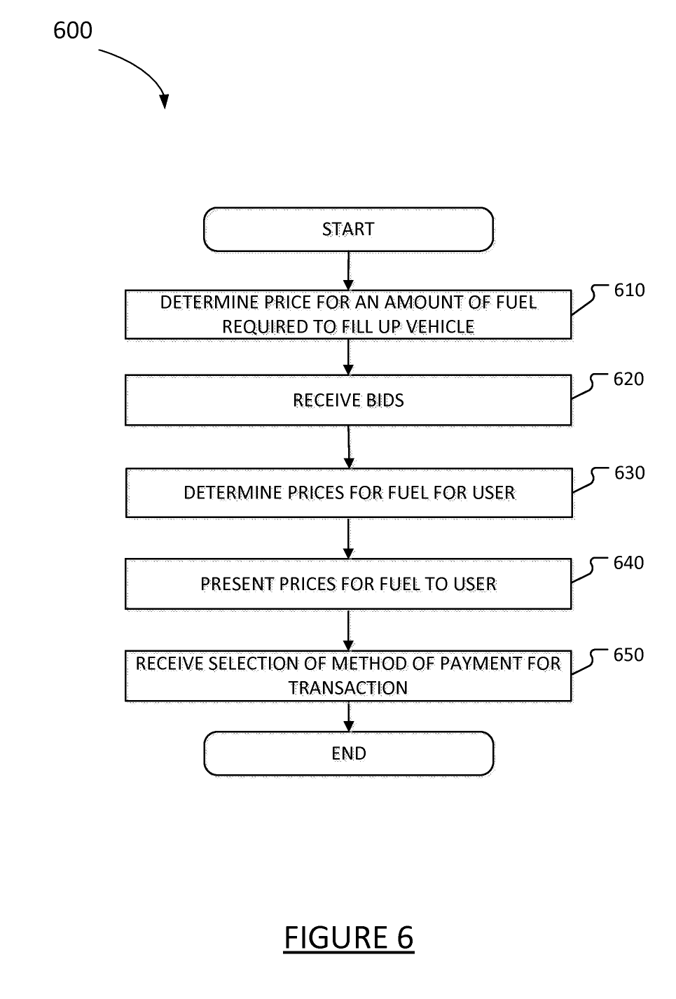

FIG. 6 illustrates a method 600 for approving a financial transaction at a gas retailer via financial institutions bidding to complete the transaction. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 500.

At operation 610, a price for a transaction may be received. The price for the transaction may be received responsive to an initiator action being triggered, wherein the initiator action is associated with a vehicle's fuel level. The price may be associated with the vehicle's fuel level upon arriving at a gas retailer, the vehicle's maximum fuel level, and a price for gas at the gas retailer. Operation 610 may be performed by a vehicle metric module that is the same as or similar to vehicle metric module 230, in accordance with one or more implementations.

At operation 620, bids from financial institutions to approve the transaction for the determined price to fill up the vehicle at the gas retailer may be received. The bids may be received from financial institutions that are linked with a method of payment associated with the user. The bids may be a percentage of the financial transaction that the financial institution may receive upon the financial transaction for the price of the fuel being completed. Operation 620 may be performed by a bidding module that is the same as or similar to bidding module 250, in accordance with one or more implementations.

At operation 630, a price for fuel the user to fill up the vehicle at the gas retailer may be determined for each bid. Because the bids may be percentage of the total cost of fuel at the gas retailer, the gas retailer's price for fuel associated with the transaction may vary based on the bids. Accordingly, the gas retailer's price for fuel may be the total price of fuel for the transaction minus the bid price. Operation 630 may be performed by a prepay module that is the same as or similar to prepay module 255, in accordance with one or more implementations.

At operation 640, the user's price for fuel at the gas retailer associated with each method of payment may be presented to the user, wherein the user's price for fuel varies based on the bid price associated with the method of payment. The user's price for fuel may be between the gas retailer's price for fuel and a transaction price for fuel using conventional methods, wherein conventional methods include a standardized three percent bid price. Operation 640 may be performed by a presentation module that is the same as or similar to presentation module 260, in accordance with one or more implementations.

At operation 650, a selection of the method of payment to complete the transaction may be received. Operation 650 may be performed by a client computing device 120 that is the same as or similar to client computing device 120, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for approving a financial transaction at a gas retailer, the system comprising:
a vehicle metric processing device configured to receive metrics associated with a vehicle and determine an initiator triggering event, the metrics including a current level of fuel within the vehicle and a maximum level of fuel for the vehicle;
a distance processing device configured to determine an amount of fuel required for the vehicle to arrive at the gas retailer;
a fuel price module configured to determine a price for a transaction at the gas retailer, the price for the transaction being based on the current level of fuel within the vehicle, the maximum level of fuel for the vehicle, the amount of fuel required for the vehicle to arrive at the gas retailer, and a fuel price at the gas retailer;
a bidding processing device configured to receive bids for the price of the transaction at the gas retailer from at least one financial institution; and
a prepay processing device configured to select a bid for the price of the transaction to complete the transaction, wherein the financial institution associated with the selected bid completes the transaction.

2. The system of claim 1, wherein the selected bid being includes a lowest percentage associated with the price for the transaction.

3. The system of claim 1, further including:
a plurality of methods of payments associated with a user of the vehicle, each of the plurality of methods of payments being linked to a financial institution, wherein the bids are received from the financial institutions associated with the methods of payments.

4. The system of claim 1, wherein when a first financial institution sets a first bid associated with a first gas retailer and a second bid associated with a second gas retailer, wherein the first financial institution is associated with the first gas retailer.

5. The system of claim 4, wherein the first bid is a lower percentage than the second bid.

6. The system of claim 1, wherein the bid is selected before the vehicle arrives at the gas retailer.

7. The system of claim 1, wherein the bids are received responsive to the triggering event, the triggering event being associated with when a current level of fuel within the vehicle is below a fuel threshold.

8. The system of claim 1, wherein a coupon is communicated to the user, an amount of the coupon is based on the selected bid and the price of the transaction.

9. The system of claim 8, wherein when the percentage associated with the selected bid is lowered and the price of the transaction is increased, the amount of the coupon increases.

10. The system of claim 1, further including:
a profile processing device configured to store a profile, the profile including methods of payments linked to different financial institutions, preselected fuel types, and preselected gas retailers.

11. A method for approving a financial transaction at a gas retailer, the system comprising:
receiving, at a vehicle metric processing device over a network, metrics associated with a vehicle, the metrics including a current level of fuel within the vehicle and a maximum level of fuel for the vehicle;
determining an triggering event;
determining an amount of fuel required for the vehicle to arrive at the gas retailer;
determining a price for a transaction at the gas retailer, the price for the transaction being based on the current level of fuel within the vehicle, the maximum level of fuel for the vehicle, the amount of fuel required for the vehicle to arrive at the gas retailer, and a fuel price at the gas retailer;
receiving, over the network, at least one bid for the price of the transaction at the gas retailer from at least one financial institution
selecting a bid for the price of the transaction to complete the transaction, wherein the financial institution associated with the selected bid completes the transaction.

12. The method of claim 11, wherein the selected bid includes a lowest percentage associated with the price for the transaction.

13. The method of claim 11, further including:
determining a plurality of methods of payments associated with a user of the vehicle, each of the plurality of methods of payments being linked to a financial institution, wherein the bids are received from the financial institutions associated with the methods of payments.

14. The method of claim 11, further including:
receiving a first bid from a first financial institution, the first being associated with a first gas retailer;
receiving a second bid from the first financial institution, the second being associated with a second gas retailer, wherein the first financial institution is associated with the first gas retailer.

15. The method of claim 14, wherein the first bid is a lower percentage than the second bid.

16. The method of claim 11, wherein the bid is selected before the vehicle arrives at the gas retailer.

17. The method of claim 11, wherein the bids are received responsive to the triggering event, the triggering event being associated with when a current level of fuel within the vehicle is below a fuel threshold.

18. The method of claim 11, further including:
communicating a coupon to the user, an amount of the coupon is based on the selected bid and the price of the transaction.

19. The system of claim 18, wherein when the percentage associated with the selected bid is lowered and the price of the transaction is increased, the amount of the coupon increases.

20. The method of claim 11, further including:
storing a profile, the profile including methods of payments linked to different financial institutions, preselected fuel types, and preselected gas retailers.
